(19) United States
(12) Patent Application Publication
(10) Pub. No.: US 2008/0226249 A1
(43) Pub. Date: Sep. 18, 2008

(54) Optical Device

(75) Inventors: Joris Franckx, Bonheiden (BE); Sam Leeman, Kessel-Lo (BE)

Correspondence Address: BAKER & DANIELS LLP, 300 NORTH MERIDIAN STREET, SUITE 2700, INDIANAPOLIS, IN, 46204, US

(73) Assignee: Tyco Electronics Raychem NV, Kessel-Lo (BE)

(21) Appl. No.: 10/586,829

(22) PCT Filed: Jan. 11, 2005
(86) PCT No.: PCT/GB2005/000093

§ 371 Date: Jul. 20, 2006

(30) Foreign Application Priority Data
Jan. 30, 2004 (GB) 0401998.0

(51) Int. Cl. G02B 6/00

(52) U.S. Cl. 385/135; 385/139

(57) ABSTRACT

An optical device comprising an enclosure having a wall member defining a cavity and a sealable fibre entry portion, an optical component located within the cavity and at least two optical fibres connected to the optical component and extending, substantially adjacent one another, through the entry portion. The invention also concerns a kit-of-parts for forming such a device, and a method of sealably enclosing an optical component.

The present invention relates to an optical device for containing an optical component, and particularly an optical device for containing a butt ended optical component. The present invention also relates to a method of sealably enclosing an optical component, and in particular a butt ended optical component.

It is well known that moisture has adverse effects on the properties of optical components. The split ratio of optical splitters, for example, may be influenced by the presence of moisture, and in optical connectors moisture may lead to increased losses. In order to overcome this problem, it is well known to provide optical components in sealed packages in order to protected the optical components against the damaging effects of moisture and other environmental influences.

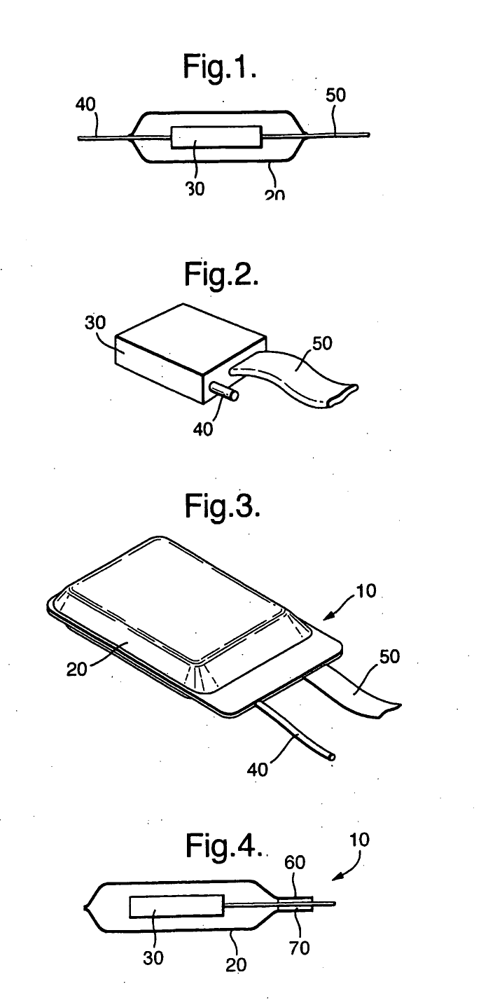

However, provision of optical components in sealed packages often results in compromised optical performance caused by stress in the optical fibres due to temperature variations which cause expansion and contraction of the packaging material and/or variations in the pressure of the atmosphere within the sealed package. In prior art packages, such as the one described in the Applicant's earlier International Patent Application No. PCT/GB03/0059, or the one shown in cross-section in FIG. 1, the fibres 40, 50 are arranged such that the optical component 30 is held in a fixed position within the enclosure 20 with the consequence that, for example, any expansion or contraction of the optical fibres 40, 50 under variations in environmental conditions, such as extreme temperature variations, will result in stress through the fibres 40, 50 thereby causing a loss of optical performance.

There is therefore a requirement for an optical device which addresses the problems of the prior art by avoiding stress through the optical fibres and the consequential loss in optical performance under variations in environmental conditions such as, for example, variations in temperature or humidity.

Accordingly, a first aspect of the present invention provides an optical device comprising an enclosure having a wall member defining a cavity and a sealable fibre entry portion, an optical component located within the cavity, and at least two optical fibres connected to the optical component and extending, substantially adjacent one another, through the entry portion.

As the optical fibres extend through the entry portion substantially adjacent one another, the optical component is held inside the enclosure in a sealed environment, thereby protected from the effects of variations in environmental conditions such as humidity. As the optical component is held in position relative to the enclosure at only one side of the component, the component is effectively free to move within the enclosure in the event that environmental conditions such as variations in temperature, cause the expansion or contraction of the optical fibres and/or other packaging elements. Thus, expansion or contraction of the fibres and/or other packaging elements is possible without stress to the fibres, as would be experienced using prior art devices. By avoiding stress in the optical fibres, the loss in optical performance that is experienced using prior art devices, is avoided.

This invention is particularly, but not exclusively directed to optical devices comprising one or more butt ended optical components. A but ended optical component is an optical component in which the optical fibre connections are located on one side of the component.

The optical component may comprise any passive component, such as, for example, a planar splitter, filter wavelength division multiplexer (FWDM), arrayed wavelength grating (AWG), isolator, filter and the like. It will be appreciated by the skilled person that these are merely examples of suitable passive components and that any other suitable passive component known to the skilled person may be located within the cavity. It will also be readily understood by the skilled person that the optical component may be any suitable active component available to the skilled person and may be used as an alternative or in addition to a passive component within the cavity of the optical device.

Preferably, the optical fibres provide incoming and outgoing fibres for the optical device.

Preferably, the fibre entry portion is arranged to receive the fibres substantially side by side as they extend through the entry portion. This allows for a better seal of the enclosure around the optical fibres if the fibres are arranged side by side, rather than being arranged such, for example, they cross over one another. More preferably, the fibres are arranged substantially parallel to one another as they extend through the fibre entry portion.

The enclosure is preferably substantially flexible, although it may alternatively be substantially rigid or at least a portion of the enclosure may be flexible while another portion of the enclosure may be rigid.

Preferably, the optical device further comprises temperature control means. By providing temperature control means, a reduction in the possibility of condensation within the device may be achieved, while in addition, excessively high and/or low temperatures may also be avoided.

The temperature control means is preferably provided in any suitable location such as within the wall member of the enclosure, or within the cavity of the enclosure.

The temperature control means may comprise a heat sink or heat pipe, and/or an active temperature controller such as a heater, for example an electrical heater and/or an active cooling element.

Alternatively, or in addition, humidity control means, such as a desiccant, may be provided to further reduce the possibility of condensation within the enclosure.

The enclosure may comprise an insulating layer. Preferably such an insulating layer is located on an interior surface of the wall member.

In a preferred embodiment, the enclosure comprises a laminar material. More preferably, the laminar material comprises a moisture resistant layer. The moisture resistant layer provides a substantially moisture resistant enclosure for surrounding the optical component. Preferably, the moisture resistant layer comprises a layer of aluminium or any other suitable metal.

Preferably, the optical component is arranged on a support, possibly with other optical components, and the optical fibres routed in accordance with a predetermined circuit configuration with the optical fibre ends fed through the entry portion for optical connection with other components. This allows for prefabrication of the optical component and optical fibres, thereby allowing for automation of the circuit assembly, and quick and simple installation of the optical component and optical fibres within the enclosure to provide an optical device according to the present invention.

The optical device may contain a single optical component located within the cavity defined by the wall member or alternatively, more than one optical component may be located within the cavity, with at least two optical fibres connected to each optical component and extending, substantially adjacent one another, through the entry portion.

A further aspect of the present invention provides a method of sealingly enclosing an optical component, the method comprising the steps of:
providing an enclosure having a wall member defining a cavity and a sealable fibre entry portion;
arranging an optical component connected to at least two optical fibres within the cavity such that the two optical fibres extend, substantially adjacent one another, through the entry portion; and
sealing the fibre entry portion so as to sealably retain the optical component within the cavity.

This provides an optical device in which the optical component or components are held in a ‘free floating’ arrangement within the cavity such that, under variations in environmental conditions, such as extreme temperature variations where expansion/contraction of the fibres and/or other packaging elements may occur, stress through the optical fibres and consequential optical loss is avoided.

Preferably, the method further comprises the step of providing a polymer strip adjacent the optical fibres at the entry portion prior to sealing the entry portion. On sealing of the fibre entry portion, the polymer strip then seals around the optical fibres, thereby sealing any gaps between the fibres and the wall member and providing an improved seal at the fibre entry portion.

The fibre entry portion may be sealed using heat and/or pressure applied at the fibre entry portion until the desired seal is achieved.

The present invention further provides a kit-of-parts for forming a device as defined above.

An embodiment of the present invention will now be described, by way of example only, and with reference to the following FIGS. 2 to 4, in which:

FIG. 2 is a perspective view of a butt ended optical component;

FIG. 3 is a perspective view of an enclosure according to an embodiment of the present invention; and

FIG. 4 is a cross sectional view of the embodiment of FIG. 3.

FIG. 2 shows a butt ended optical component 30 with an incoming optical fibre 40 and an outgoing optical fibre 50, the incoming optical fibre 40 and the outgoing optical fibre 50 both arranged on the same side of the optical component 30, in a so-called butt ended arrangement. Such an optical component is shown in FIGS. 2 and 3 as part of an embodiment of an optical device according to the present invention.

FIGS. 3 and 4 show an optical device 10 according to the present invention comprising an enclosure 20 defining a sealable fibre entry portion in which an optical component 30 is contained. The enclosure 20 is sealed around the incoming and outgoing optical fibres 40 and 50 of optical component 30 such that the optical component 30 is held in a ‘free floating’ arrangement within the enclosure 20. In other words, and as is clearly shown in the cross sectional view of FIG. 4, the incoming and outgoing optical fibres 40 and 50 are held substantially adjacent one another at the entry portion 60 when the entry portion 60 is sealed, thereby holding the optical component within the enclosure 20 such that the optical component is anchored at one side only relative to the enclosure. A sealing strip 70 is provided between the fibres 40, 50 and the wall member of the enclosure 20 at the fibre entry portion 60.

Thus, in the sealed optical device 10, the optical component 30 is free to move within the enclosure 20 in the event of contraction and/or expansion of the optical fibres 40, 50 and/or other packaging elements, due to variations in environmental conditions such as temperature variations. Therefore, on expansion and/or contraction of the optical fibres 40, 50 and/or other packaging elements, the optical component 30 is free to move within the enclosure 20, thereby avoiding stress on the fibres 40, 50 as would occur if the optical component 30 was not free to move, but instead was rigidly held within the enclosure 20, as is the case in prior art optical devices. By preventing stress on the optical fibres, optical quality is maintained and optical losses avoided.

Although aspects of the invention have been described with reference to the embodiment shown in the accompanying drawings, it is to be understood that the invention is not limited to the precise embodiment shown and that various changes and modifications may be effected without further inventive skill and effort. For example, the enclosure may accommodate more than one optical component, and may define one or more sealable fibre entry portions, provided each optical component is held in a ‘free-floating’ arrangement relative to the enclosure, as described above.

1. An optical device comprising an enclosure having a wall member defining a cavity and a sealable fiber entry portion, an optical component located within the cavity and at least two optical fibers connected to the optical component and extending, substantially adjacent one another, through the entry portion.

2. An optical device according to claim 1, wherein the optical fibers provide an incoming and outgoing fiber for the optical component.

3. An optical device according to claim 1, wherein the fiber entry portion is arranged to receive the at least two fibers substantially side-by-side as they extend through the entry portion.

4. An optical device according to claim 3, wherein the optical fibers are arranged substantially parallel to one another as they extend through the entry portion.

5. An optical device according to claim 1, wherein at least a portion of the enclosure is flexible.

6. An optical device according to claim 1, further comprising temperature control means.

7. An optical device according to claim 1, wherein the enclosure comprises a laminate.

8. An optical device according to claim 7, wherein the laminate comprises a moisture resistant layer.

9. An optical device according to claim 8, wherein the moisture resistant layer comprises aluminum.

10. An optical device according to claim 1, wherein the enclosure comprises an insulating layer.

11. An optical device according to claim 1, wherein the optical device comprises a plurality of optical components located within the cavity, and at least two optical fibers connected to each optical component and extending, substantially adjacent one another, through the entry portion.

12. An optical device according to claim 11, wherein the wall member defines a plurality of fiber entry portions, such that each optical component is associated with a separate fiber entry portion through which the optical fibers to which each individual optical component is connected extend through a separate fiber entry portion to the optical fibers connected to other optical components.

13. An optical device according to claim 1, wherein the enclosure is of a size and shape for fitting into an optical fiber organizer tray.

14. A fiber optic organizer tray assembly, comprising:
an optical fiber organizer tray;
an optical device comprising an enclosure having a wall member defining a cavity and a sealable fiber entry portion;
an optical component located within the cavity and at least two optical fibers connected to the optical component and extending, substantially adjacent one another, through the entry portion; and
said enclosure being profiled for fitting into said optical fiber organizer tray.

15. A method of sealingly enclosing an optical component, the method comprising the steps of:
providing an enclosure having a wall member defining a cavity and a sealable fiber entry portion;
arranging an optical component connected to at least two optical fibers within the cavity such that the two optical fibers extend, substantially adjacent one another, through the entry portion; and
sealing the fiber entry portion so as to sealably retain the optical component within the cavity.

16. A method according to claim 15, further comprising the step of providing a polymer strip adjacent the optical fibers at the entry portion prior to sealing the entry portion.

17. A method according to claim 15, wherein the fiber entry portion is sealed using heat and/or pressure
